(19) United States
(12) Patent Application Publication
(10) Pub. No.: US 2003/0022018 A1
(43) Pub. Date: Jan. 30, 2003

(54) Inks for electroluminescent devices and a method for preparation thereof

(75) Inventors: Israel Baumberg, Maale Adumim (IL); Oleg Berezin, Maale Adumim (IL); Boris Gorelik, Beit Shemesh (IL); Moshe Voskoboinik, Maale Adumim (IL)

Correspondence Address: BROWDY AND NEIMARK, P.L.L.C., 624 NINTH STREET, NW, SUITE 300, WASHINGTON, DC, 20001-5303, US

(73) Assignee: Elam Electroluminescent Industries Ltd.

(21) Appl. No.: 09/860,775

(22) Filed: May 21, 2001

(51) Int. Cl. H05B 33/12; C09K 11/00

(52) U.S. Cl. 428/690; 428/917; 313/509; 427/66; 523/200; 524/544; 524/413; 524/436; 252/301.36

(57) ABSTRACT

An ink composition for use in a dielectric or electroluminescent (EL) layer of an EL device, as well as a method of preparation of such composition, are presented. The composition comprises a water-based dispersion of a hydrophobic polymer with a high dielectric constant, rheological additives and a dielectric powder or EL phosphor powder.

### FIELD OF THE INVENTION

The present invention relates to an electroluminescent (EL) light source and a method of manufacturing thereof.

### BACKGROUND OF THE INVENTION

Conventional AC powder EL type devices include at least one layer containing EL phosphor and at least one layer containing a dielectric powder with a high dielectric constant. To obtain these layers, inks (pastes) are usually applied in the form of a solution of a polymer with high dielectric constant, in which particles of either a dielectric material (typically, barium titanate or titanium oxide) or a powder of EL phosphor are dispersed for obtaining, respectively, dielectric or EL layers. The deposition of inks (pastes) is carried out by screen printing or pulverization, or by dip coating. After the deposition process, the layers are dried resulting in the evaporation of the solvent and the hardening of the layers. The polymer solutions typically used in inks (pastes) include cyanoethylated compounds such as cyanoethylated ethylene-vinyl alcohol copolymer, cyanoethylated cellulose, cyanoethylated pullulan, cyanoethylated starch, cyanoethylated saccharose, cyanoethylated glycerine, etc. Fluoropolymers, such as polyvinylidene fluoride, vinylidene fluoride-hexafluoropropylene copolymer, vinylidene fluoride-tetrafluoroethylene-hexafluoropropylene terpolymer, etc., can also be used in the inks. To prepare the inks, these polymers are dissolved in organic solvents, such as ketones, glycols, DMF, etc. All these solvents are more or less toxic, and some of them are flammable and explosive. When dealing with mass production, the vapors of these solvents pollute the environment. Moreover, the frequent use of these solvents presents potential danger for personal health.

### SUMMARY OF THE INVENTION

There is accordingly a need in the art to facilitate the manufacture of EL devices by providing novel ink compositions and a method of their manufacture suitable for mass production. The inks according to the invention for use in the fabrication of dielectric and luminescent layers of EL light sources do not contain any solvents harmful to the environment, are suitable for deposition and drying processes with standard equipment, and provide the desired quality of the layers.

Thus, according to one aspect of the present invention, there is provided an ink composition comprising a water-based dispersion of a hydrophobic polymer with a dielectric constant of no less than 6 (at 1 kHz and 25° C.), rheological additives and a powder containing particles of a dielectric or EL material.

Preferably, the aqueous dispersions of the hydrophobic polymer are based on fluoropolymer material. In this case, for one weight part of dry fluoropolymer, the following relative concentrations (in weight percentage) of the other components may be used: 0.25-4 parts of water, 0.001-0.1 parts of rheological additives, and 1.5-15.0 parts of EL phosphor or 1.5-15.0 parts of a dielectric powder. The fluoropolymer may be PVDF based elastomer (Latex) or PVDF based thermoplastic polymer.

In order to improve the quality of inks, they may contain anti-foam agents, for example, an emulsion of modified polysiloxane and/or surface active agents, for example, fluoroorganic surfactants.

Preferably, the dielectric particles or EL phosphor powder used in the water based ink of the invention have hydrophobic surface.

The rheological additives may be thixotropic agents, thickeners and flow modifiers. Thixotropic agents are organic titanium chelates. Organic chelates include triethanolamine and/or 2,2′-oxydiethanol and/or diethylenglycol and/or ethylenglycol and/or triisopropanoamine. According to a preferred embodiment, bis(triethanolamine) titanium di(methyl diglycolate)—trade name Tyzor ETAM from Du Pont and or titanium glycol alkanolamine complexes—trade name Tyzor TA 300, TA 400, are used as thixotropic agents.

Thickeners are rheological additives which at low concentrations can effectively change the viscosity of a coating system. In the case of water based coatings having usually low viscosity, thickeners provide rheological profiles needed for each application. According to a preferred embodiment, polyether urea polyuretanes—trade name Rheolate 210, Rheolate 216 by Rheox Inc. or trade name Nopco DSX 1550 by Henkel or polyether polyols—trade name Rheolate 350, Rheolate 300 by Rheox Inc.

Flow modifiers are rheological additives which provide a homogeneous coating without flow fractures and drops appearing. Flow modifiers are water soluble polyacrylates. According to a preferred embodiment, a pre-neutralized aqueous solution of an acrylic copolymer—trade name Modaflow AQ-3000, by Solutia Inc. is used as a flow modifier.

While the hydrophobic polymer is a fluoropolymer, the composition preferably also includes an anti-foam agent, for example, an emulsion of modified polysiloxane at a ratio of 0.002-0.05 weight parts for one part of the dry fluoropolymer. In addition to the anti-foam agent, the composition may also comprise other surfactants. If the fluoropolymer is a PVDF based elastomer, the ink composition also includes a curing agent, for example, piperazine dipropanamine at a ratio of 0.001-0.1 parts for one part of the PVDF based elastomer.

The dielectric powder may be a barium titanate powder. The EL powder may be in encapsulated form. The surface of the particles of the EL phosphor powder or dielectric powder may be modified by hydrophobic agents e.g., fluorosilicons or perfluoropolyethers.

According to another aspect of the present invention, there is provided a method of preparation of an ink composition of a dielectric powder comprising the steps of:

(i) dispersing a dielectric powder in water together with a thixotropic agent;

(ii) preparing a polymeric solution of a thickening agent;

(iii) mixing a water dispersion of a hydrophobic polymer with at least one anti-foam agent;

(iv) mixing said polymer solution obtained in step (ii) above with said water dispersion of polymer prepared in step (iii);

(v) adding the dispersion prepared in step (i) into the mixture obtained in step (iv), thereby obtaining a mixture presenting the ink composition; and

(vi) introducing a flow modifier into the composition of step (v).

The hydrophobic polymer is preferably a fluoropolymer, for example PVDF based material. The PVDF based material may be a thermoplastic polymer, or an elastomer, in which case a curing agent is added into the mixture obtained in step (v).

According to yet another aspect of the present invention, there is provided a method of preparation of an ink composition of EL phosphor powder comprising the steps of:

(a) adding at least one anti-foam agent into a water dispersion of a hydrophobic polymer;

(b) preparing a solution of a polymeric thickening agent;

(c) mixing said polymer solution of thickening agent with the dispersion prepared in step (a);

(d) mixing the mixture obtained in step (c) with an EL phosphor powder, thereby obtaining the ink composition.

The hydrophobic polymer is preferably a fluoropolymer, for example PVDF. The PVDF based material may be a thermoplastic polymer, or an elastomer, in which case a curing agent is added into the mixture obtained in step (c).

### BRIEF DESCRIPTION OF THE DRAWINGS

In order to understand the invention and to see how it may be carried out in practice, a preferred embodiment will now be described, by way of non-limiting example only, with reference to the accompanying drawing:

FIG. 1 illustrates an electroluminescent light source utilizing links according to the invention.

### DETAILED DESCRIPTION OF THE INVENTION

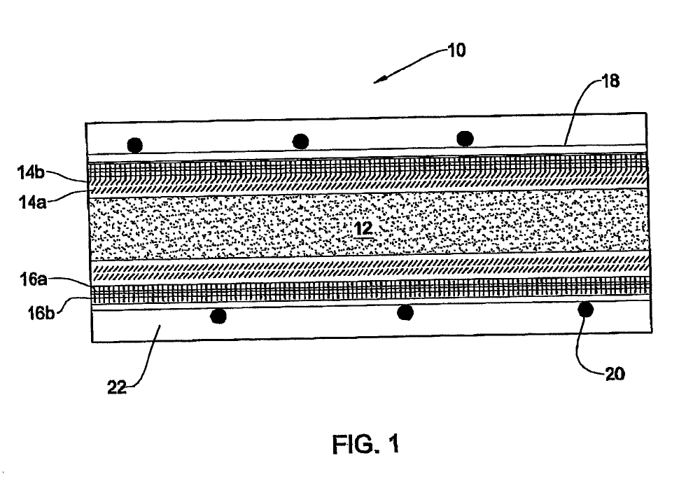

Referring to FIG. 1, there is illustrated an EL light source 10 in the form of wire utilizing inks according to the invention. The light source 10 comprises a central wire-like electrode 12 sequentially coated by identical dielectric layers 14a and 14b, and identical EL layers 16a and 16b. In order to obtain the dielectric layer 14a, an ink wet layer with the thickness of 100 μm is deposited by dip coating onto the surface of the central wire electrode 12 and then dried to form the layer 14a with the thickness of 15 μm. The layer 14b also has a thickness of 15 μm and is obtained in a similar manner. The EL layers 16a and 16b with typical thickness of 25 μm each, are obtained in a similar manner, namely, by ink deposition and drying procedures. A transparent electrode 18 is formed on the outer surface of the layer 16b by depositing an indium-tin oxide (ITO) layer with a thickness of 400-500 Å. A wire electrode 20 is clamped to the surface of the transparent electrode 18 by means of a polymer insulating layer 22, and provides contact to the transparent electrode 18.

The dielectric and EL layers are accommodated concentrically with the central electrode 12. The thickness and concentricity of layers are defined by using floating dies of a specific form. The EL light source 10 emits light in response to the application of AC voltage to the electrodes.

In the present example, the drying of layers is carried out in a continuous process in a 6 m height vertical column formed by an array of furnaces. The temperature at the entrance of column is 60° C., and at the exit from the column is 190° C. The velocity of the wire path through the column is 9 cm/sec. The central electrode is a copper wire of the 0.5 mm diameter. The experimental results have shown that such EL wires are characterized by a brightness of 50 cd/m² and more and by a half-life time of brightness not less than 1400 hours at the applied voltages of VAC=120V and the frequency of 400 Hz.

The following are two examples of the ink compositions for dielectric and EL phosphor layers, respectively, which were used in the fabrication of the above-described device 10.

### EXAMPLE1

### Ink for Dielectric Layers

| Material | Type | % |
|---|---|---|
| Fluoroelastomer based Latex | Fluorobase 100 commercially | 28.2 |
| | available from Ausimont | |
| Deionized Water | | 23.4 |
| Curing Agent | Fluorobase T-520 commercially | 0.2 |
| | available from Ausimont | |
| Barium Titanate | HPB commercially available | 46.6 |
| | from TAM Ceramics | |
| Thixotropic agent - organic | TYZOR ETAM commercially | 0.5 |
| titanium chelate | available from Dupont | |
| Rheological additive - flow | Modaflow AQ 3000 commercially | 0.5 |
| modifier | available from Solutia | |
| Rheological additive - | Nopeo DSX 1550 commercially | 0.3 |
| thickener | available from Henkel | |
| Anti-foam agent | Serdas GBR commercially | 0.3 |
| | available from Servo Deldon BV | |

### EXAMPLE 2

### Ink for EL Phosphor Layers

| Material | Type | % |
|---|---|---|
| Water dispersion of fluoro | THV 340CD commercially available | 49.3 |
| thermoplastic polymer | from Dyneon | |
| EL Phosphor | IPHS001 commercially available | 49.3 |
| | from Durel | |
| Thixotropic agent - organic | TYZOR ETAM commercially | 0.5 |
| titanium chelate | available from Dupont | |
| Rheological additive - flow | Modaflow AQ 3000 commercially | 0.5 |
| modifier | available from Solutia | |
| Rheological | Rheolate 300 commercially available | 0.5 |
| additive-thickener | from Rheox | |
| Anti-foam agent | Serdas GBR commercially available | 0.4 |
| | from Servo Delden BV | |

The following two examples of ink compositions are also suitable to be used for the fabrication of dielectric and phosphor layers, respectively.

### EXAMPLE 3

### Ink for Dielectric Layers

| Material | Type | % |
|---|---|---|
| Water dispersion of | THV 220D commercially available | 55 |
| Fluorothermoplastic | from Dyneon | |
| Polymer | | |
| Barium Titanate | HPB commercially available | 43 |
| | from TAM Ceramics | |
| Thixotropic agent - organic | TYZOR ETAM commercially | 0.5 |
| titanium chelate | available from Dupont | |
| Rheological additive - flow | Modaflow AQ 3000 commercially | 0.5 |
| modifier | available from Solutia | |
| Rheological | Rheolate 208 commercially available | 0.5 |
| additive-thickener | from Rheox | |
| Anti-foam agent | Serdas GBR commercially available | 0.5 |
| | from Servo Delden BV | |

### EXAMPLE 4

### For Phosphor Layers

| Material | Type | % |
|---|---|---|
| Fluoroelastomer based Latex | Fluorobase 100 commercially | 37.4 |
| | available from Ausimont | |
| Deionized Water | | 12 |
| Curing Agent | Fluorobase T-520 commercially | 0.3 |
| | available from Ausimont | |
| EL Phosphor | ANE430 commercially available | 49.4 |
| | from Sylvania | |
| Rheological additive - flow | Modaflow AQ 3000 commercial | 0.3 |
| modifier | available from Solutia | |
| Rheological | Rheolate 300 commercially | 0.3 |
| additive-thickener | available from Rheox | |
| Anti-foam agent | Serdas GBR commercially | 0.3 |
| | available from Servo Delden BV | |

Thus, the advantages of the present invention are self-evident. The environmentally friendly inks for EL light sources according to the invention are based on aqueous dispersions of hydrophobic polymers with high values of dielectric constant, rather than the conventionally used solutions of polymers in organic solvents. The EL light sources utilizing the inks of the present invention are characterized by high values of brightness and half-life.

1. An ink composition comprising a water-based dispersion of a hydrophobic polymer with a dielectric constant of no less than 6, rheological additives and a dielectric powder or electroluminescent phosphor powder.

2. The composition according to claim 1, wherein said hydrophobic polymer is a fluoropolymer.

3. The composition according to claim 2 wherein for one weight part of a dry fluoropolymer, the ratio in weight percentage of the other components being: 0.25-4 parts of water, 0.001-0.1 parts of rheological additives, and 1.5-15.0 parts of dielectric powder.

4. The composition according to claim 2, wherein for one weight part of a dry fluoropolymer, the ratio in weight percentage of the other components being: 0.25-4 parts of water, 0.001-0.1 parts of rheological additives, and 1.5-15.0 parts of EL phosphor powder.

5. The composition according to claim 3, wherein the fluoropolymer is a PVDF based elastomer.

6. The composition according to claim 4, wherein the fluoropolymer is a PVDF based elastomer.

7. The composition according to claim 5 or 6, also including a curing agent.

8. The composition according to claim 7, wherein the curing agent is piperazinedipropanamine in a ratio of 0.001-0.1 parts for one part of the PVDF based elastomer.

9. The composition according to claim 3, wherein the fluoropolymer is a PVDF based thermoplastic polymer.

10. The composition according to claim 4, wherein the fluoropolymer is a PVDF based thermoplastic polymer.

11. The composition according to claim 2, also including an anti-foam agent.

12. The composition according to claim 11, wherein the anti-foam agent is an emulsion of a modified polysiloxane in a ratio of 0.002-0.05 weight parts for one part of the dry fluoropolymer.

13. The composition according to claim 1 wherein said rheological additives include thixotropic agent and/or flow modifer and/or thickener.

14. The composition according to claim 1, also comprising anti-foam agent and others surfactants.

15. The composition according to claim 1, wherein the dielectric powder is a barium titanate powder.

16. The composition according to claim 1, wherein the particles of the electroluminescent phosphor powder are encapsulated.

17. The composition according to claim 1, wherein the surface of the particles of the EL phosphor powder or dielectric powder is modified by hydrophobic additives.

18. The composition according to claim 1, wherein the surface of the particles of the EL phosphor powder or dielectric powder is modified by fluorosilicones or perfluoroethers.

19. A method of preparation of an ink composition of a dielectric powder comprising the steps of:
(i) dispersing a dielectric powder in water together with a thixotropic agent;
(ii) preparing a polymeric solution of a thickening agent;
(iii) mixing a water dispersion of a hydrophobic polymer with at least one anti-foam agent;
(iv) mixing said polymer solution obtained in step (ii) above with said water dispersion prepared in step (iii);
(v) adding the dispersion prepared in step (i) into the mixture formed in step (iv) above, thereby obtaining the ink composition and
(vi) introducing a flow modifier into the composition of step (v).

20. The method according to claim 19, wherein said hydrophobic polymer in step (iii) is a fluoropolymer.

21. The method according to claim 19, wherein said thixotropic agent includes organic titanium chelates.

22. The method according to claim 21 wherein the organic moiety of the organic titanium chelates comprises triethanolamine and/or 2,2′ oxydiethanol and/or diethylenglycol, and/or ethylenglycol and/or triisopropanolamine.

23. The method according to claim 19, wherein said polymer solution for the thickening agent is selected from solutions of polyurethaneurea in water or polyether in water.

24. The method according to claim 19, wherein said anti-foam agent is an emulsion of a modified polysiloxane.

25. The method according to claim 20, wherein said fluoropolymer is a PVDF based elastomer, the method also including the step of mixing a curing agent with the mixture obtained in step (iv), prior to injecting the dispersion prepared in step (i).

26. A method of preparation of an ink composition of an EL phosphor powder comprising the steps of:
(a) adding at least one anti-foam agent into a water dispersion of a hydrophobic polymer;
(b) preparing a polymeric solution of a thickening agent;
(c) mixing said polymer solution with the dispersion prepared in step (a);
(d) mixing an EL phosphor powder with the mixture of said polymer solution and the dispersion prepared in step (a), thereby obtaining the ink composition and
(e) introducing a flow modifier into the composition of step (d).

27. The method according to claim 26, wherein said hydrophobic polymer in step (a) is a fluoropolymer.

28. The method according to claim 27, wherein said fluoropolymer is a PVDF based material.

29. The method according to claim 28, wherein said PVDF based material is a thermoplastic polymer.

30. The method according to claim 26, wherein said anti-foam agent is an emulsion of a modified polysiloxane.

31. The method according to claim 26, wherein said polymer solution for the thickening agent is selected from solutions of polyurethaneurea in water or polyether in water.

32. The method according to claim 28, wherein said PVDF based material is elastomer, the method also comprising the step of mixing a curing agent with the mixture obtained in step (c), prior to mixing it with the EL phosphor powder.

33. The method according to claim 32, wherein said PVDF based elastomer is used in the form of water based Latex.

34. An electroluminescent (EL) light source comprising a first wire electrode, sequentially coated with at least one dielectric layer, at least one EL phosphor layer, and a second electrode, wherein said at least one dielectric layer is made of a dielectric powder based ink composition comprising a water based dispersion of a hydrophobic polymer with a dielectric constant of no less than 6, rheological additives and a dielectric powder material, and said at least one EL phosphor layer is made of an EL phosphor powder based ink composition comprising a water based dispersion of a hydrophobic polymer with a dielectric constant of no less than 6, rheological additives and an EL phosphor powder.

35. A method of manufacturing an EL light source of claim 34, the method comprising the steps of sequentially coating a central wire electrode with at least one dielectric layer, at least one EL phosphor layer, and a second electrode, wherein each of the at least one dielectric and at least one EL coating being carried out by depositing the corresponding ink composition onto the surface of an underlying layer and drying the ink composition.
